(19) United States
(12) Patent Application Publication
(10) Pub. No.: US 2004/0009005 A1
(43) Pub. Date: Jan. 15, 2004

(54) Image reading apparatus

(75) Inventors: Takayuki Suga, Ibaraki (JP); Hiroaki Takagishi, Tokyo (JP); Takeshi Aoyama, Chiba (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/615,306

(22) Filed: Jul. 9, 2003

(30) Foreign Application Priority Data
Jul. 9, 2002 (JP) 2002-200024

(51) Int. Cl. G03G 21/20

(52) U.S. Cl. 399/94

(57) ABSTRACT

An image reading apparatus having an original base unit on which an original is placed, a light source for illuminating the original on the original base unit, a light-receiving unit for receiving light reflected from the original, air blasting unit for sending air in the direction away from the light source, and a wall surface for allowing air sent from the air blasting unit toward the light source.

This application claims the right of priority under 35 U.S.C. §119 based on Japanese Patent Application No. JP 2002-200024, filed on Jul. 9^{th}, 2002, which is hereby incorporated by reference herein in its entirety as if fully set forth herein.

### BACKGROUND OF THE INVENTION

1. Field of the Invention

The present invention relates to an image reading apparatus for reading an image by irradiating a light beam emitted from a light source onto an original and photoelectrically converting a light beam reflected from the original.

2. Description of the Related Art

In the related art, an image reading apparatus used in a copying machine, a scanner, or a facsimile apparatus is constructed to illuminate an original with a lamp, image diffused light from the original by a lens, and read the image by a CCD (Charge Coupled Device).

In recent years, it is becoming increasingly necessary to increase the light quantity in association with increased reading speed and improved image quality, and thus there arises a problem of rise in temperature of the lamp.

In addition, in an image reading apparatus employing an Auto Document Feeder (hereinafter referred to as “ADF”) for feeding originals automatically, it is a general trend to employ “running reading” for reading an image while keeping the lamp ON in a stationary state and transporting the original, and thus such continuous lighting of the lamp is a principal factor to cause rise in temperature.

In order to solve such problem, JP-A-8-179676 discloses a method of cooling a lamp, as shown in FIG. 7, in which fans are disposed in the vicinity of a home position of the lamp for a normal copying mode and in the vicinity of the position at which the lamp is located during running reading by the ADF, respectively, and the lamps are cooled by being directly exposed to air sent from those fans.

However, in the arrangement disclosed in JP-A-8-179676 as shown in FIG. 7, there is such problem that when a lamp 701 is kept ON continuously during running reading, and a cooling fan 702 provided in the vicinity of the position of running reading is rotated, the surface temperature of the lamp becomes significantly different between the far side, which is closer to the fan 702, and the near side, which is far from the fan 702, due to the facts that the speed of air is different between the far side of the lamp, which is closer to the fan 702, and the near side, which is far from the fan 702, and that the near side of the lamp is exposed to air which is warmed up by drawing heat from the far side of the lamp 702. When there is a significant difference in surface temperature of the lamp, characteristics of the light-emitting member vary depending on the temperature, and hence intensity of illumination also varies.

FIG. 8 shows an example of a result of measurement in which variations in temperature distribution and variations in illuminance distribution in the longitudinal direction of the lamp are measured when the lamp is cooled by being directly exposed to air sent from the fan on the far side of the lamp with an arrangement as shown in JP-A-8-179676.

As shown in FIG. 8, it was proved that when the lamp was kept ON for a several minutes, the light quantity distribution of the lamp measured immediately after being turned on was significantly different from the light quantity distribution after continuous illumination due to generation of temperature difference of the lamp in the longitudinal direction thereof.

When the shape of the light quantity distribution has varied as shown in FIG. 8, the light quantity cannot be compensated, and thus such phenomena that part of the image gets dark or, in a color image reading apparatus, colors are changed due to disruption of a balance of R, G, and B may occur.

### SUMMARY OF THE INVENTION

Accordingly, an object of the invention is to provide an image reading apparatus in which variations in the shape of light quantity distribution is minimized.

Another object of the invention is to provide an image reading apparatus in which the temperature difference between one side and the other side of the lamp is minimized.

Further object of the invention is to provide an image reading apparatus comprising: an original base unit on which an original is placed; a light source for illuminating the original on the original base unit; a light-receiving unit for receiving light reflected from the original; air blasting unit for sending air in the direction away from said light source; and a wall surface for allowing air sent from said air blasting unit toward said light source.

Further objects, features and advantages of the invention will become apparent from the following description of the preferred embodiments.

### BRIEF DESCRIPTION OF THE DRAWINGS

FIG. 1 is a cross-sectional view showing a general construction of an image reading apparatus according to a first embodiment;

FIG. 2 is a plan view of the image reading apparatus shown in FIG. 1;

FIG. 3 is a drawing showing another construction of the first embodiment;

FIG. 4 is a drawing showing a general construction of the image reading apparatus according to a second embodiment;

FIG. 5 is a drawing showing a general construction of the image reading apparatus according to a third embodiment;

FIG. 6 is a drawing showing another construction of the third embodiment;

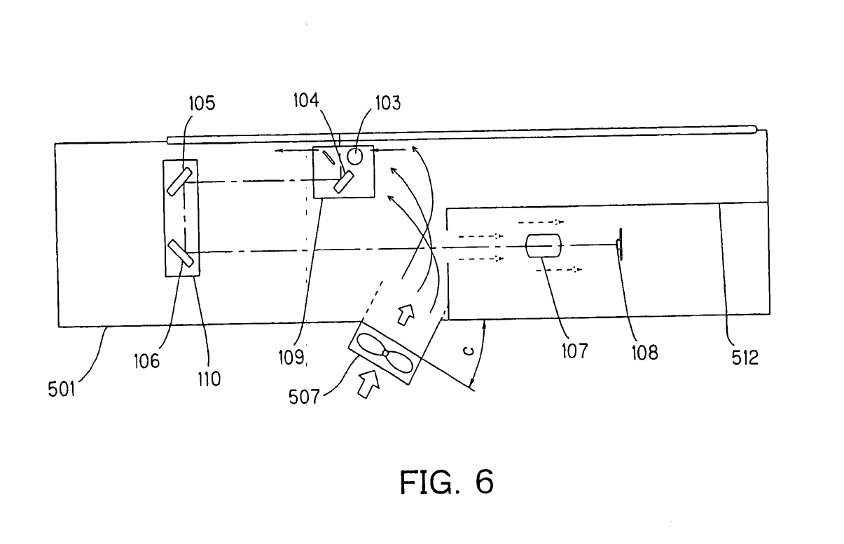

FIG. 7 is a plan view of the image reading apparatus in the related art;

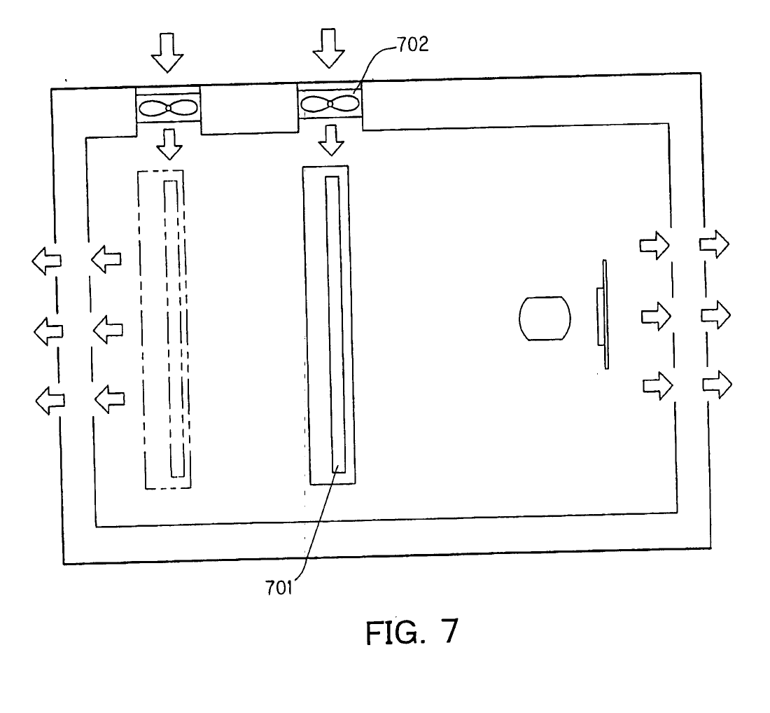

FIG. 8 shows an example of measurement in which variations in the temperature distribution and the light quantity distribution of a light source are measured when the light source is cooled by using an image reading apparatus in the related art; and

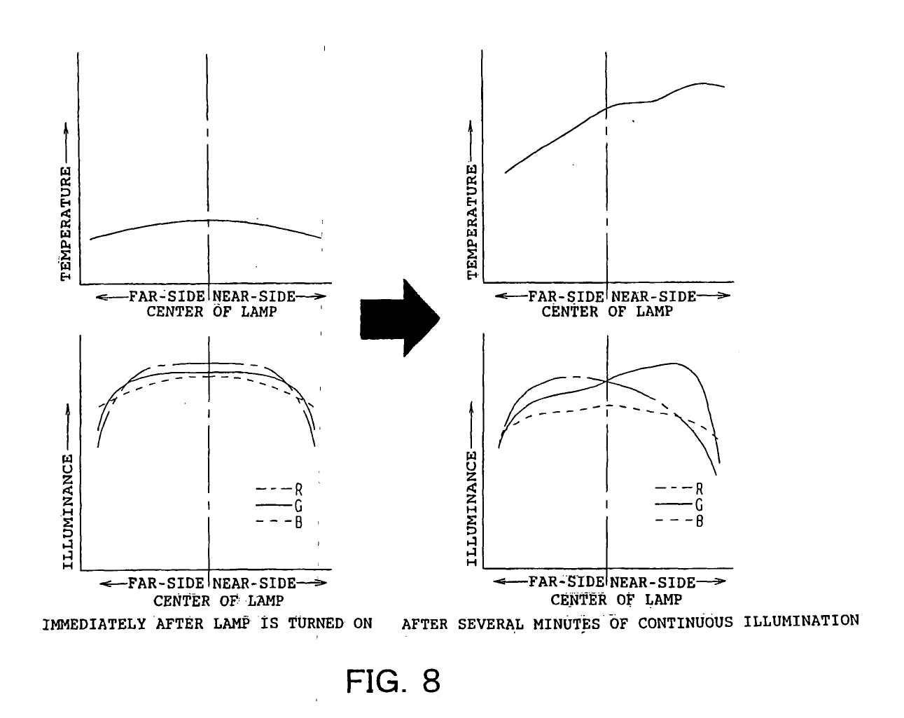

FIG. 9 shows an example of measurement in which variations in the temperature distribution and the light quantity distribution of a light source are measured when the light source is cooled by using the image reading apparatus according to the invention.

### DESCRIPTION OF THE PREFERRED EMBODIMENTS

Referring now to the drawings, the preferred embodiments of the invention will be described in detail by way of example. Dimensions, material, configurations, and relative locations of components stated in the embodiments are not intended to limit the scope of the invention unless otherwise stated.

### (First Embodiment)

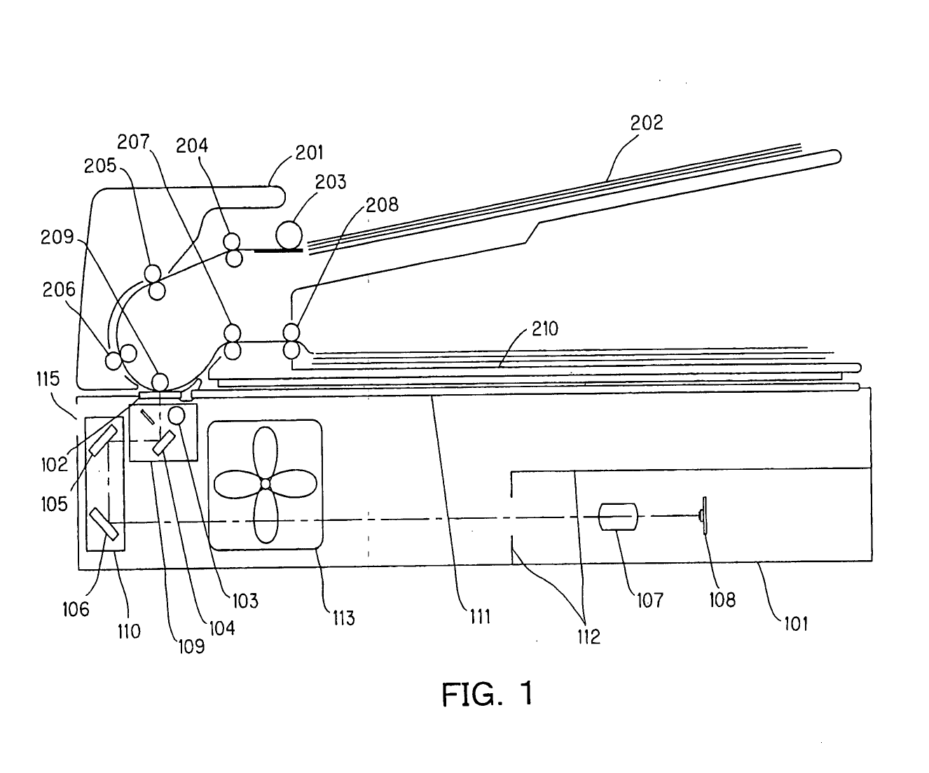

FIG. 1 is a cross-sectional view showing a general construction of an image reading apparatus according to a first embodiment of the invention.

An original 202 set in an ADF 201 constructed to be detachable and attachable with respect to an image reading apparatus body 101 is fed onto a running reading glass 102 of the apparatus body 101 by transport rollers 203 to 208 and a platen roller 209, and then is collected on a discharge tray 210.

The apparatus body 101 includes a light source 103 for illuminating the original via the glass 102 or a glass 111, mirrors 104, 105 and 106 for guiding reflected light from the original to the light receiving unit, an image forming lens 107, and a CCD (Charge Coupled Device) 108 for photoelectrically converting a light image and supplying electric signals. The light source 103 and the mirror 104 are mounted to the first optical base 109, and the mirrors 105 and 106 are mounted to the second optical base 110. In light scanning unit having the light source 103, the mirrors 104, 105 and 106, and the optical bases 109 and 110, the optical bases 109 and 110 connected to a stepping motor (not shown) via a wire are controlled to move in parallel to the original base glass 111 by revolution of the stepping motor.

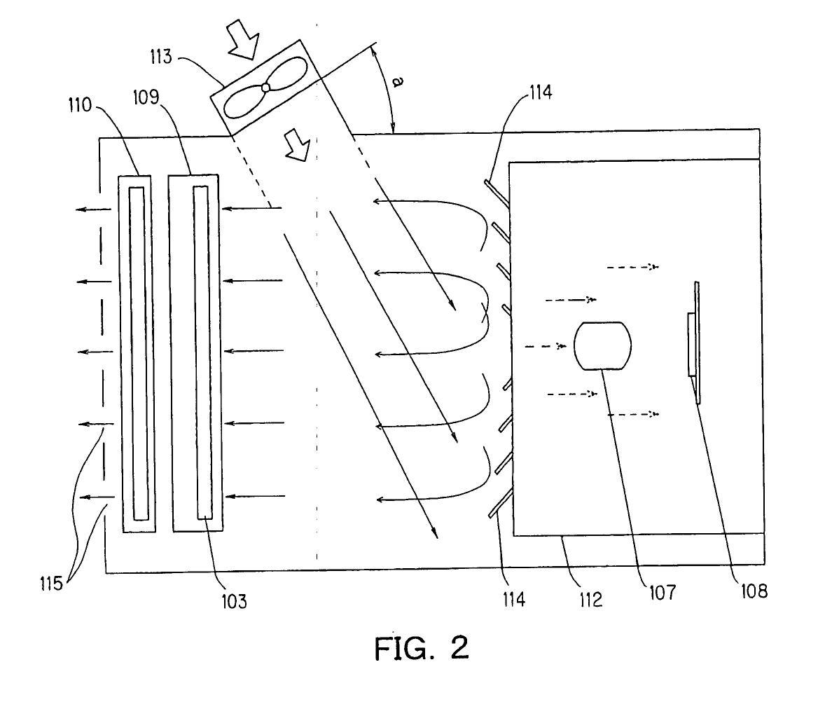

The apparatus body 101 is provided with a CCD cover 112 for shielding the area around the CCD so that electrically radiated noise generated from a CCD drive circuit, which is driven at a high speed, does not leak out a scanner body, and the CCD cover 112 is provided with a rectifying plate 114 at the left side thereof, as shown in FIG. 2.

In this arrangement, when performing running reading that the original being transported by the action of the ADF 201 is read, the first optical base 109 is moved to a predetermined running reading position by the stepping motor, not shown and stopped there.

The original 202 is transported by the transport rollers 203 to 208 and the platen roller 209. A light beam is irradiated from the light source 103 onto the original being transported between the running reading glass 102 and the platen roller 209, and is optically scanned by the CCD 108 via the first mirror 104, the second mirror 105, the third mirror 106, and the lens 107.

Since a plurality of originals may be placed on the ADF 201, the light source 103 is kept ON continuously until scanning of all the originals are completed, which causes rise in temperature of the lamp. Therefore, as shown in FIG. 2, a fan 113 for sending air from the outside into the image reading apparatus is disposed on a far-side wall surface of an enclosure of the image reading apparatus at the position corresponding to the right side of the light source 103 within a short distance therefrom when the first optical base 109 is stopped during running reading, rotates while the light source 103 is in an ON state, and sends air from the outside into the image reading apparatus for cooling the light source 103.

FIG. 2 is a plan view of the image reading apparatus shown in FIG. 1. The ADF 201 is not shown in FIG. 2.

The positions of the first optical base 109 and the second optical base 110 shown in FIG. 2 are those where they are stopped during running reading.

The fan 113 is mounted to the wall surface of the enclosure of the image reading apparatus at an angle of a so as to face the opposite direction from the light source 103, so that the position of the light source 103 during running reading comes outside the range which directly receives air sent from the fan 113 (the range indicated by dotted lines in the drawing).

When the fan 113 is rotated during running reading, air sent from the fan 113 hits against the wall surface of the CCD cover 112 as shown by an arrow in FIG. 2, changes its direction on the rectifying plate 114, which corresponds to rectifying unit, provided on the wall surface, and proceeds to the light source 103. Therefore, air passes through the area around the light source 103 at a substantially uniform speed along the entire length of the light source 103, draws generated heat from the light source 103, and is discharged from the apparatus through a louver 115 provided on the side surface of the image reading apparatus.

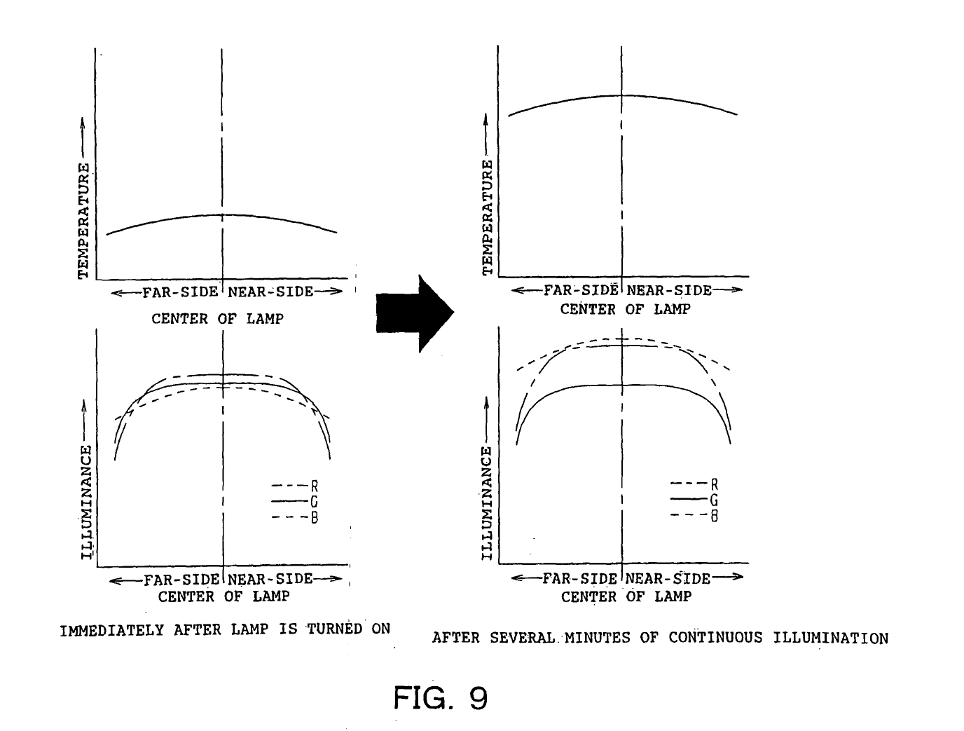

In this manner, air can be supplied to the light source uniformly over the entire length thereof and thus the difference in temperature on the light source along the length thereof may be eliminated by causing air sent by air blasting unit to hit against the wall surface of the CCD cover 112 existing down the passage of air sent by the air blasting unit, change its direction and proceed toward the light source, not by sending air directly to the light source. FIG. 9 shows the temperature distribution and the light quantity distribution of the lamp according to this embodiment. As shown in FIG. 9, the shape of the light quantity distribution is not changed even after the lamp has been kept ON continuously.

The CCD cover 112 is provided with an opening (not shown) for securing an optical path from the third mirror 106 to the image forming unit 107 disposed in the CCD cover, and part of flowing air proceeding toward the wall surface of the CCD cover 112 enters from the opening into the CCD cover 112, and flows around the lens 107 and the CCD 108.

Accordingly, dewdrops that may be generated on the lens 107 or the CCD 108 when the room temperature of the space where the image reading apparatus is placed is abruptly increased can be eliminated sooner than in the related art.

Although air is directed toward the light source 103 by the existence of the wall surface of the CCD cover 112 even when the rectifying plate 114 is not provided, it is preferable to provide the rectifying plate 114 in order to cause air to proceed most effectively toward the light source at a most uniform speed.

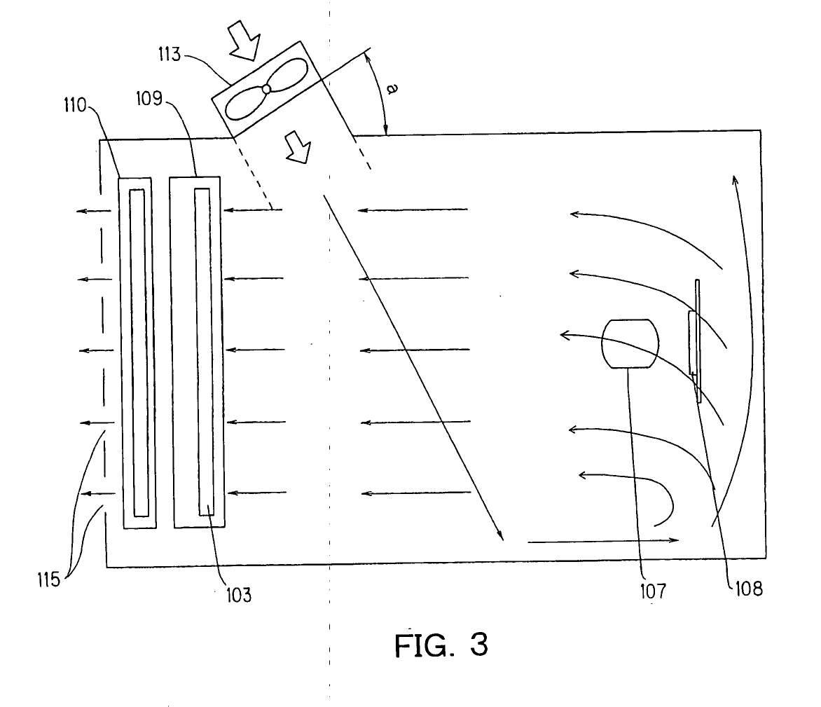

When the CCD cover 112 is not provided, or when the fan 113 can only be disposed at the position away from the position at which the light source 103 is located during running reading, it is also possible to direct air toward the light source by using the wall surface of the enclosure of the image reading apparatus body, as shown in FIG. 3. In this case, airflow having effective and uniform speed can be generated by also providing a same rectifying plate as that provided on the wall surface of the CCD cover in FIG. 2 on the wall surface of the enclosure of the image reading apparatus body. However, when the distance between the wall surface and the light source increases, the cooing efficiency is lowered correspondingly, and thus it is preferable to use the wall surface which is closer to the light source.

When providing the CCD cover 112, by forming a large hole or a number of small holes on the side surface or the upper surface of the CCD cover in order to allow a lager quantity of air to flow in the CCD cover, dewdrops may effectively be eliminated sooner.

The position to arrange the fan is not limited to the far-side wall surface of the enclosure of the image reading apparatus as shown in FIGS. 2 and 3, and the same effect as this embodiment is achieved even when it is disposed on the near-side wall surface of the enclosure.

The number of fans is not limited to one, and thus it is possible to increase the cooling effect by providing a plurality of fans. Therefore, it is preferable to determine the number of fans to be installed, according to the environment of the image reading apparatus, while considering the power consumption, noise of the fan, and so on.

### (Second Embodiment)

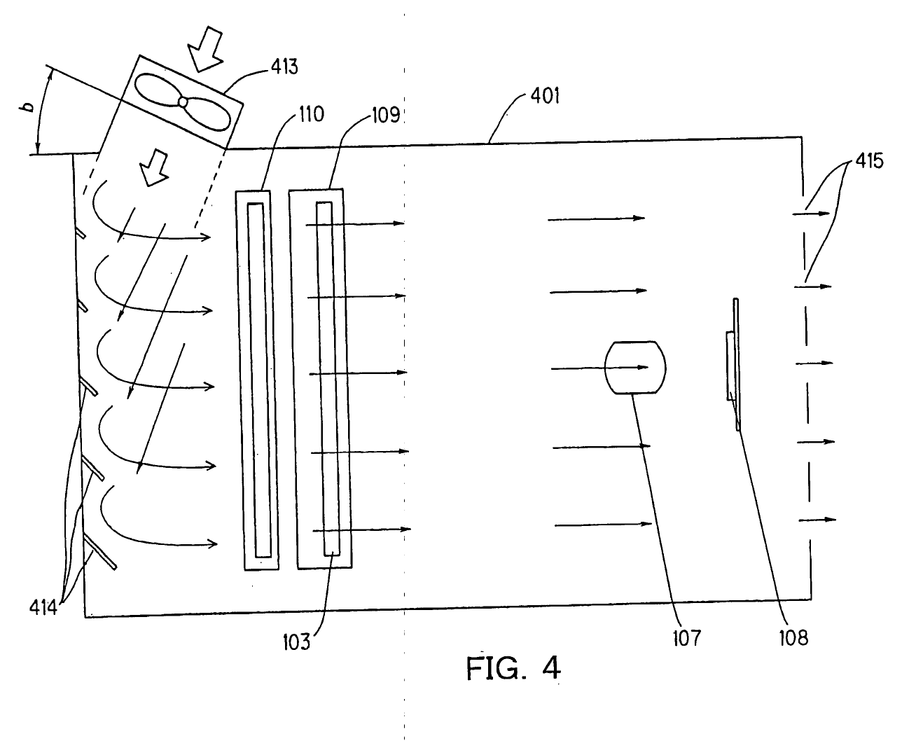

Referring now to FIG. 4, the second embodiment will be described. The positions of the first optical base 109 and the second optical base 110 in FIG. 4 are the positions where they stop for performing running reading by the ADF. In this embodiment, the position of a fan 413 is changed from the first embodiment and arranged on the left side of the position where the light source 103 stops for running reading. A rectifying plate 414 is provided on the wall surface of the enclosure of the image reading apparatus, which extends in parallel with the longitudinal direction of the light source 103 at the closest position therefrom.

The fan 413 is disposed on the far-side wall surface of the enclosure of the image reading apparatus on the left side of and in the vicinity of the position where the light source 103 stops when the first optical base 109 is stopped for running reading at an angle of b so as to face the opposite direction from the light source 103, so that the position of the light source 103 during running reading comes outside the range which directly receives air sent from the fan 413 (the range indicated by dotted lines in the drawing). The fan 413 rotates while the light source 103 is kept ON, and sends air from the outside into the image reading apparatus to cool the light source 103.

As shown in FIG. 4, air sent by rotation of the fan 413 into the apparatus hits against the wall surface of the enclosure of the image reading apparatus, which is located at the closest position to the fan 413, and changes its direction on the rectifying plate 414 provided on this wall surface, and proceeds to the light source 103. Then air passes around the light source 103 at a substantially uniform speed along the entire length of the light source 103. During this passage, air draws heat generated from the light source and is discharged toward the outside through a louver 415 provided on the opposite side surface of the enclosure frame of the image reading apparatus.

In this manner, difference in temperature on the light source along the length thereof may be prevented from occurring by applying air uniformly to the light source over the entire length thereof. Therefore, the shape of the light quantity distribution does not vary as shown in FIG. 9 even after the lamp has been kept ON continuously.

Although air is directed toward the light source by the existence of the wall surface of the enclosure of the image reading apparatus even without the rectifying plate 414, it is preferable to provide the rectifying plate 414 in order to cause air to proceed more effectively toward the light source at a more uniform speed.

The position to arrange the fan is not limited to the far-side wall surface of the enclosure of the image reading apparatus, and the same effect as this embodiment is achieved even when it is disposed on the near-side wall surface of the enclosure.

The number of fans is not limited to one, and thus it is possible to increase the cooling effect by providing a plurality of fans. Therefore, it is preferable to determine the number of fans to be installed, according to the environment of the image reading apparatus, while considering the power consumption, noise of the fan, and so on.

### (Third Embodiment)

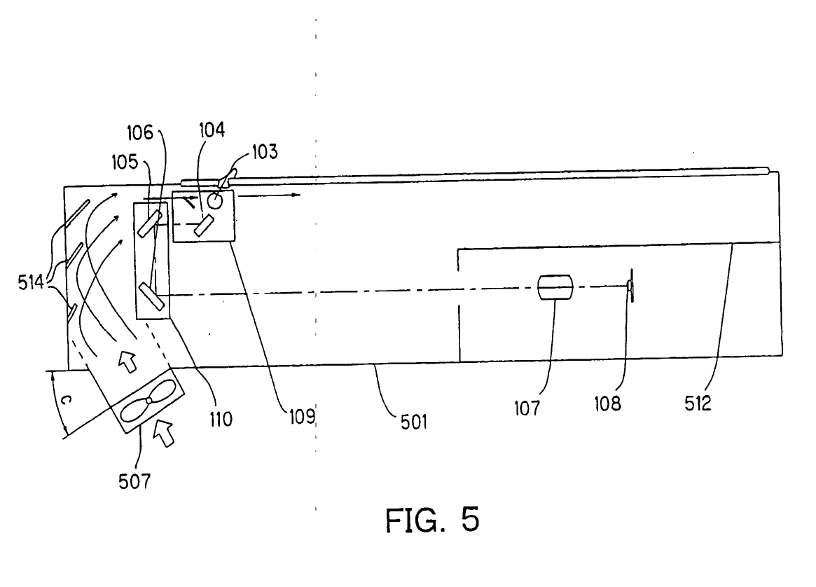

Referring now to FIG. 5, the third embodiment will be described. The positions of the first optical base 109 and the second optical base 110 in FIG. 5 are the positions where they stop for performing running reading by the ADF. In this embodiment, the position of a fan 513 is changed from the first embodiment, and arranged on the bottom of the image reading apparatus on the left side of the position where the light source 103 stops for running reading. A rectifying plate 514 is provided on the wall surface of the enclosure of the image reading apparatus, which extends in parallel with the longitudinal direction of the light source 103 at the closest position therefrom.

Since other constructions and the operations are the same as the first embodiment, the identical components are represented by the identical numerals and will not be described.

As shown in FIG. 5, the fan 513 is disposed on the bottom of the enclosure of the image reading apparatus in the vicinity of the lower left of the position where the light source 103 stops when the first optical base 109 stops for running reading at an angle of c so as to face the opposite direction from the light source 103, so that the position of the light source 103 during running reading comes outside the range which directly receives air sent from the fan 513 (the range indicated by dotted lines in the drawing). The fan 513 rotates while the light source 103 is kept ON, and sends air from the outside into the image reading apparatus to cool the light source 103.

As shown in FIG. 5, air sent by rotation of the fan 513 into the apparatus hits against the wall surface of the enclosure frame of the image reading apparatus, changes its direction on the rectifying plate 514, and proceeds to the light source 103.

The fan 513 sends air substantially vertically with respect to the length of the light source. However, since it spreads longitudinally of the light source (the direction vertical to the plane of FIG. 5) in the process of reaching the light source, it passes around the light source 103 at a substantially uniform speed over the entire length of the light source 103. During this passage, air draws heat from the light source.

In this manner, difference in temperature on the light source along the length thereof maybe prevented from occurring by applying air to the light source substantially uniformly over the entire length thereof. Therefore, the shape of the light quantity distribution does not vary as shown in FIG. 9 even after the lamp has been kept ON continuously.

Although air is directed to the light source by the existence of the side surface of the frame of the image reading apparatus even without the rectifying plate 514, it is preferable to provide the rectifying plate 514 in order to cause air to proceed more effectively toward the light source at a more uniform speed, as in the case of the first and the second embodiments.

Although the construction in which air sent from the fan is directed to the light source using the side surface of the enclosure frame of the image reading apparatus is shown in FIG. 5, it is also possible to provide the fan 513 on the bottom of the enclosure of the image reading apparatus on the right side of the light source 103 to allow air to be directed to the light source 103 by using the wall surface of a CCD cover 512 as in the case of the first embodiment. In this case, since a large amount of air can be flown inside the CCD cover 512, generation of dewdrops on the lens or the CCD caused by abrupt increase in room temperature may be effectively eliminated sooner than in the related art.

The number of fans is not limited to one, and thus it is possible to increase the cooling effect by providing a plurality of fans.

Especially, when the distance from the fan to the light source is obliged to be short due to the limitation of the width or the thickness of the frame body, air sent from the fan cannot be spread sufficiently, and thus the light source may not be cooled uniformly along the entire length thereof with a single fan. In such a case, by arranging a plurality of fans along the length of the light source, air may be sent to the area around the light source at a further uniform speed.

Therefore, it is preferable to determine the number of fans to be installed, according to the environment of the image reading apparatus, while considering the power consumption, noise of the fan, and so on.

As is described above, according to the invention, in an image reading apparatus including a light source for illuminating an original and reading the original transported with respect to the stationary light source, air blasting unit for sending air from the outside into the image reading apparatus is provided, the air blasting unit is directed so that the light source in a stationary state does not directly receive air sent from the air blasting unit, and air sent from the air blasting unit changes its direction on a wall surface existing down the passage of air sent from the air blasting unit, and proceeds to the light source. Therefore, the light source does not receive air sent from the air blasting unit directly, but air which has changed its direction on the wall surface existing down the passage of air sent from the air blasting unit is applied to the light source uniformly over the entire length of the light source. Consequently, difference in temperature on the light source along the length thereof may not occur even after the light has been kept ON continuously. Therefore, such phenomena that part of the image gets dark or colors are changed due to disruption of a balance of R, G, and B may be prevented, whereby the image quality is stabilized.

Since the air blasting unit is arranged on the wall surface of the image reading apparatus in an inclined manner with respect to the wall surface of the enclosure so as to face the direction opposite from the light source, air can be applied to the light source uniformly over the entire length of the light source more effectively.

Since rectifying unit for rectifying air from the air blasting unit is provided on the wall surface existing down the passage of air sent from the air blasting unit, air can be applied to the light source at a substantially uniform speed along the entire length of the light source.

The wall surface existing down the passage of air sent from the air blasting unit is a wall surface of the enclosure of the image reading apparatus, which extends in parallel with the longitudinal direction of the light source at the closest position therefrom. Therefore, air is applied to the light source before the wind-force is weakened, and thus cooling efficiency may be increased.

The uniform air can be applied to the light source effectively even when the wall surface of the cover for covering the photoelectric conversion unit for photoelectrically converting an optical image obtained by light scanning unit for scanning the image on the original and a drive circuit for driving the photoelectric conversion unit is used as the wall surface existing down the passage of air sent from the air blasting unit.

In addition, when image forming unit for forming an optical image obtained by the light scanning unit is provided in the cover and an opening for guiding a light beam from the light source into the image forming unit is formed on the cover, since air flows through the opening into the cover, dewdrops on the image forming unit or the CCD caused by abrupt increase in room temperature may be eliminated sooner than in the related art.

When an opening for guiding air from the air blasting unit into the cover is formed on at least one of the wall surface of the cover existing down the passage of air sent from the air blasting unit and the upper surface thereof, dewdrops on the image forming unit or the CCD caused by abrupt increase in room temperature may be eliminated much sooner.

While the invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims.

1. An image reading apparatus comprising:
an original base unit on which an original is placed;
a light source for illuminating the original on the original base unit;
a light-receiving unit for receiving light reflected from the original;
air blasting unit for sending air in the direction away from said light source; and
a wall surface for allowing air sent from said air blasting unit toward said light source.

2. An image reading apparatus according to claim 1, wherein said light source is rod-shape, and said air blasting unit sends air in the direction inclined with respect to the longitudinal direction of said light source.

3. An image reading apparatus according to claim 2, wherein said air blasting unit comprises a fan, and said fan is attached to an enclosure of said apparatus in an inclined manner.

4. An image reading apparatus according to claim 2, the wall surface is provided with a plurality of rectifying plates for rectifying air directed to said light source along the entire length of said light source.

5. An image reading apparatus according to claim 1, wherein said air blasting unit is provided on the bottom of an enclosure of said apparatus.

6. An image reading apparatus according to claim 1, wherein said light source is rod-shape, and said wall surface and said light source are substantially parallel with each other.

7. An image reading apparatus according to claim 1, wherein the light-receiving unit is a photoelectric conversion member for photoelectrically converting a light beam reflected from the original, said apparatus comprises said photoelectrical conversion member and a cover for covering a driver of said photoelectrical conversion member, and the wall surface is a surface of the cover, which opposes said light source.

8. An image reading apparatus according to claim 7, wherein said wall surface comprises a hole for allowing a light beam reflected from the original to pass.

9. An image reading apparatus according to claim 8, wherein said cover is provided with, an image forming lens for forming an image of the original on said photoelectric conversion member.
